(19) United States
(12) Patent Application Publication
(10) Pub. No.: US 2002/0087346 A1
(43) Pub. Date: Jul. 4, 2002

(54) Utilization of competencies as drivers in a learning network

(76) Inventor: Scott T. Harkey, Clearwater, FL (US)

Correspondence Address: Wendy W. Koba, Esq., PO Box 556, Springtown, PA, 18081, US

(21) Appl. No.: 10/000,264

(22) Filed: Nov. 28, 2001

Related U.S. Application Data
(60) Provisional application No. 60/253,394, filed on Nov. 28, 2000.

(51) Int. Cl. G06F 17/60; G06F 7/00; G06F 17/00; G09B 1/00

(52) U.S. Cl. 705/1; 707/104.1; 706/925; 706/927; 434/433

(57) ABSTRACT

A learning network is formed that includes “competencies” as content objects in the network, in addition to learning objects and knowledge objects. The nodes forming the network for linked in an individual pattern for each user accessing the network, thus allowing the learning network to be used by both novices and experts. The network includes data retrieval utilities that are configured to continuously access external sources of information to update the content stored in the network. Each network access by a user creates an updated relational table between the nodes, forming a dynamic interconnection of nodes so that the learning network provides improved response to each user during each subsequent access.

### CROSS-REFERENCE TO RELATED APPLICATION

This application claims the benefit of Provisional Application No. 60/253,394, filed Nov. 28, 2000.

### TECHNICAL FIELD

The present invention relates to learning networks and, more particularly, to the utilization of competencies as “content” for a learning network, the competencies being assimilated by indexing utilities into the learning network.

### BACKGROUND OF THE INVENTION

The reinvention of the learning landscape over the past decade has significantly tested the ability of training organizations to become more efficient and accountable for their “return on investment”. This fundamental change in the work environment has been the product of investors wanting larger monetary return for less investment of capital. The resulting “pay for performance” ideology has placed a premium on acquiring a diverse set of competencies, while de-emphasizing company loyalty and job security. The real challenge facing training organizations, therefore, is not “return on investment”, but rather training employees on an ever-increasing set of competencies in progressively more complex environments where employees are not as loyal as in the past. Where once training focused on relatively straightforward procedures, employees are now empowered to make decisions, solve problems, and adapt to situations across all levels within an organization.

Compounding the issue of training organization efficiency is that as the complexity of jobs has increased, so has the amount of information necessary to understand the relevant competencies. Historically, training organizations have been concerned with structured content that is controlled using widely accepted instructional systems design methodologies. In other words, learning was structured around clear objectives related to content deemed appropriate to a given job function. The rapid rate of change in the core competencies of most jobs today, however, has limited the ability of training organizations with limited resources and budgets to react quickly enough to meet the learning needs of its employees. Consequently, employees have begun to turn to both the internet and corporate intranets as repositories of learning information (e.g., “Lessons Learned” websites, knowledge portals, and the like).

Although many learning leaders may suggest that the content on these sites is inappropriate for training since it is unstructured and uncontrolled, their place in the learning landscape cannot be ignored. Indeed, the International Data Corporation (IDC) has predicted that the daily content on corporate intranets will rise from just over 200 terabytes of information per day to almost 1200 terabytes by the year 2006. Undeniably, a significant percentage of this unstructured information is business critical knowledge that, if harnessed, would provide a powerful source of learning to employees.

Current leaning theories offer few, if any, suggestions for tapping into such a rich resource of uncontrolled content while simultaneously providing controlled objective-based training. Most learning theories are still based on traditional behaviorism principles limiting the ability to map the complex cognitive processes necessary to utilize the various modes of information. Due to the cognitive complexity of competencies in current and future job functions, a cognitive architecture that is not limited by behaviorism principles would provide a more robust foundation for training.

Two cognitive models of learning are recognized in the prior art: the serial processing model and the parallel processing model. The serial processing model is widely recognized as a result of the work of Jean Piaget on the capacity of short-term memory. Short-term memory, according to Piaget, is defined in the model as being limited to an aggregate of seven items, while long-term memory has a limitless capacity. Items in short-term memory are represented symbolically and processed serially in discrete steps. The items then transfer from short-term memory to specific locations in long-term memory with retrieval cues through repetition and limited association. Without repetition, the information in short-term memory quickly degrades.

The serial processing cognitive architecture is ideal for more simple associations as found in the stimulus-response behaviorism learning theories. With a limited capacity of short-term memory and an inability to process multiple pieces of information simultaneously, short-term memory in this architecture creates a “bottleneck” in the learning process. Employees, faced with more complex competency tasks, struggle to manage the encoding of information in an environment in which significant amounts of knowledge are presented simultaneously in a short period. Since items are represented symbolically in discrete locations within long-term memory, recall errors are common, due to poor encoding strategies, which will reduce motivation to apply learned knowledge and skills. This interpretation is strengthened by the work of Ebbinghaus' “forgetting theory”, published around the turn of the twentieth century, in which upwards of 40% of content (using nonsense syllables instead of semantically meaningful content) learned was lost within the first 20 minutes of being learned. Ebbinghaus found that interventions such as rereading of materials after the initial learning event significantly reduced content loss. In the current cognitive model, it could be argued that by reviewing the material, employees are providing an opportunity for short-term memory to process the information with strong encoding cues in long-term memory.

Another limitation of the serial processing cognitive architecture is that the learned material is discretely placed within long-term memory without significant association to other items. For instance, an instructor may provide information based on personal work experiences that the learner (employee) does not understand due to a lack of similar experience. Consequently, the employee may encode the information in a manner inconsistent with the instructor's inventions. The result is that the employee, when faced with the instructor's example, may not be able to recall the pertinent information, due to encoding cues that were inconsistent with the intentions of the learning environment created by the instructor. Since the learned information is stored in a discrete location in long-term memory with limited associations to other material, individuals ,ay have difficulty applying this information into another work setting due to a lack of flexible retrieval cues.

The alternative parallel processing cognitive architecture model is based on neural networking's premise of excitatory properties of the neuron. In this model, learning is conceptualized as a network of linked concepts, defined as nodes, in which information is recalled via the activation of correlated nodes across the network. For instance, as shown in FIG. 1, the concept of “fire” is represented in a network with all of its associated information linked in the system. The more relevant the information to the individual's understanding of fire, the closer the two items reside in the network.

As an individual acquires more experience in an environment, the relationships between nodes strengthen, resulting in aggregation of information commonly defined as a “chunk”, as shown in FIG. 2. As additional experience is obtained, these “chunks” are further interconnected to form more robust representations of human behavior, memory, and information processing, defined as “schemas”. Referring again to FIG. 2, the progression from nodes, to chunks and then to schemas creates a “learning network” comprising an endless combination of interconnected information that may be capable of representing competencies at all levels of complexity.

Although the parallel processing architecture is not restricted by limitations in the short-term memory, the acquisition of competencies is shown to be gradual. Knowledge existing in this type of system is considered implicit and outside the awareness of the individual, but is accessible when the entire node pattern is activated. As shown in FIG. 3, however, the example of the instructor's information being interpreted and encoded differently by two individuals does not result in the absolute loss of information. As shown, an “abstract” thinker and a “concrete” thinker encode the concept of “fire” quiet differently. The encoding of fire's relationship to “water” in both learning networks, however, results in the entire node pattern being activated and thus recalled. The implication for training is that regardless of the ability of the individual to encode information as intended by the instructor, it is likely that enough similarity between the intended pattern and the actual pattern of encoding will result in recall on demand of the learned information. This ability in the architecture to create unique, personal learning networks accounts for individual differences in learning styles, as well as cognitive abilities to store and access information.

Although the parallel processing model provides a theoretical foundation rich in explanations for the learning of competencies, the fact remains that learners must encode the information in the architecture. Unfortunately, not all employees encode equally. Specifically, novice learners tend to focus on serial processing, resulting in memory limitations and poor recollection of stored information. Experts, on the other hand, create encoding synergy by incorporation multiple types of information into their learning networks. By managing their memory systems, experts are also able to leverage their current encoding and retrieval strategies in long-term memory to assimilate new information. This self-monitoring skill lows experts to examine and judge the effectiveness of their problem-solving strategies. Research has demonstrated that experts tend to constantly self-regulate their progress on resolving a problem, while novices will continue down a path for significant periods of time without considering its effectiveness at reaching resolution. Researchers have suggested that these metacognitive differences may exist because experts have more schemas to reference, which eases the need to working (short-term) memory to process new information. Consequently, experts are able to use their working memory to monitor, rather than process, the integration of new information and strategies into the existing structure because the new schema overlays with existing schemas in their learning network with more logic than that in possession of a novice. In other words, experts are able to maximize the incorporation of new data because they can relate new competency information to their existing knowledge and skill in memory. This ability by experts allows them to maximize the strengths of both the serial and parallel processing architectures.

The differences between expert and novice learners provide evidence that one of the most critical competencies for an employee is associated with learning. Unfortunately, as the competencies associated with jobs become more complicated and the time for training decreases due to the “needs of the business”, the opportunity for individuals to evaluate training resources decreases. For novice learners, this may be a moot point since they lack the skills and knowledge to be able to navigate all of the available learning resources. On the other hand, expert learns are likely to be overwhelmed by the amount of information available in both controlled and uncontrolled environments. In both situations, neither type of employee fully realizes his or her learning potential, due to an inability to create a complete “learning network” (as illustrated in FIG. 1).

### SUMMARY OF THE INVENTION

In light of all of these limitations of the prior art, the present invention is directed to the capability of creating a custom “learning network” for each indvidual (be it for an expert, novice, or an individual with a few years experience). Each learning network is configured to dynamically account for all information, both controlled and uncontrolled, that is considered by the business “owners/executives” to be important for the task of acquiring job-specific competencies and overall organization success. The system, in accordance with the present invention, is capable of mimicking the parallel processing model of the prior art, meaning that all content (regardless of source) is treated equally so that node patterns (i.e., relationships between the nodes) may be developed.

The node patterns, chunks and schemas are designed, in accordance with the present invention, to provide individuals with mapped learning solutions to specific competency deficits. For the purposes of the present invention, the term “competency” is defined as an underlying characteristic of an individual that relates to job performance.

The assimilation of competencies into a learning network as the principal driver of training represents a significant evolution in the learning model. Instead of integrating competencies as word strings in a search engine, competencies are treated as “content” and assimilated by the indexing utilities into the learning network. This process requires limited integration of existing systems into a learning architecture and reduces the need for meta-tagging and definitive guidelines for chunking of information, since the index automatically acquires the related information.

Other and further aspects of the present invention will become apparent during the course of the following discussion and by reference to the accompanying drawings.

### BRIEF DESCRIPTION OF THE DRAWINGS

Referring now to the drawings:

FIG. 1 illustrates an exemplary, simplified “learning network”, this particular network involving the concept of “fire”, and illustrating the various associated nodes;

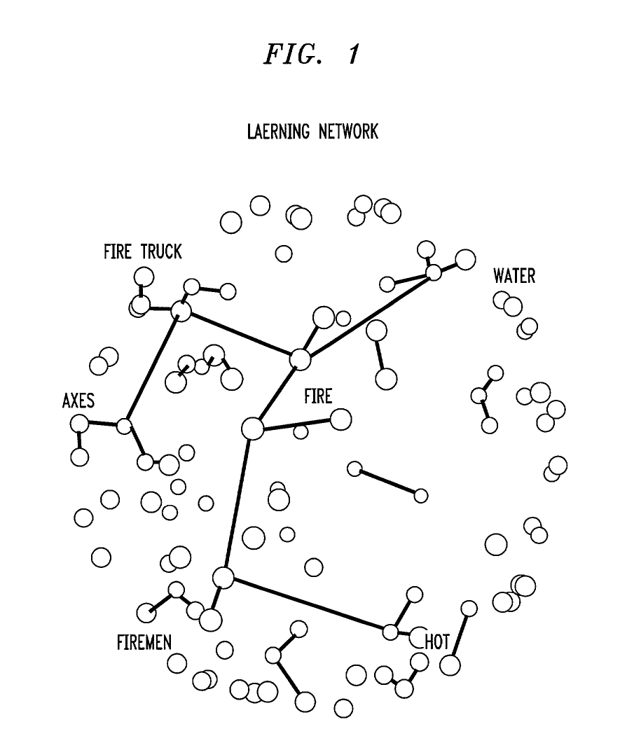

FIG. 2 illustrates the evolution from a “node”, to a “chunk”, to a “schema” in the creation of a learning network;

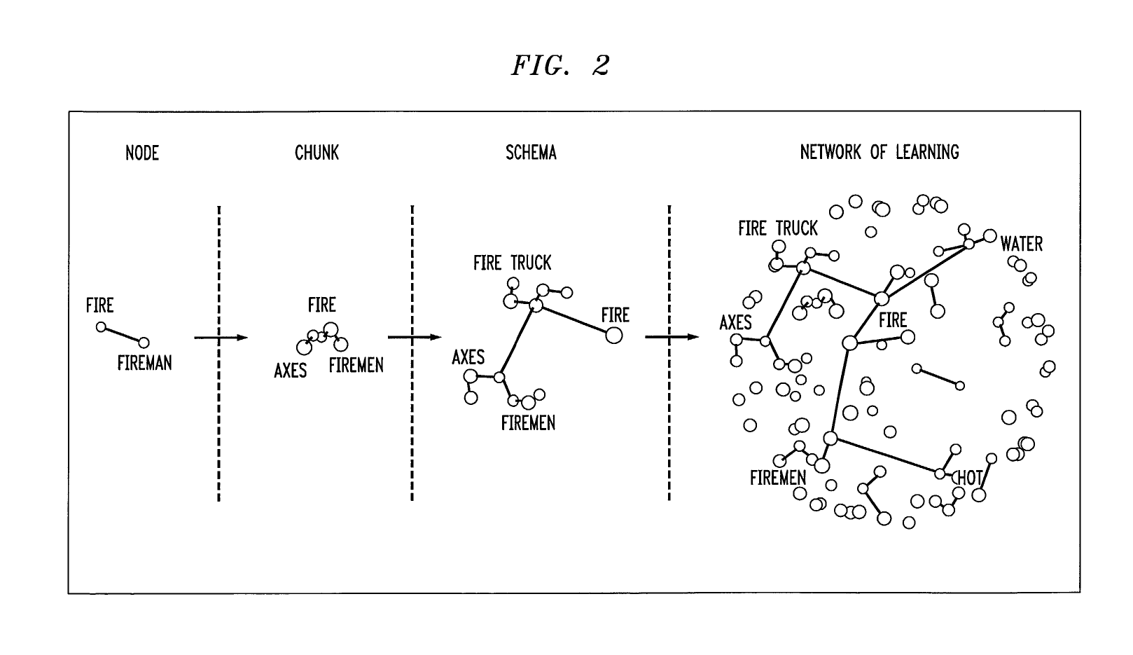

FIG. 3 compares learning networks (again involving the concept of “fire”), for both an abstract learner and a concrete learner;

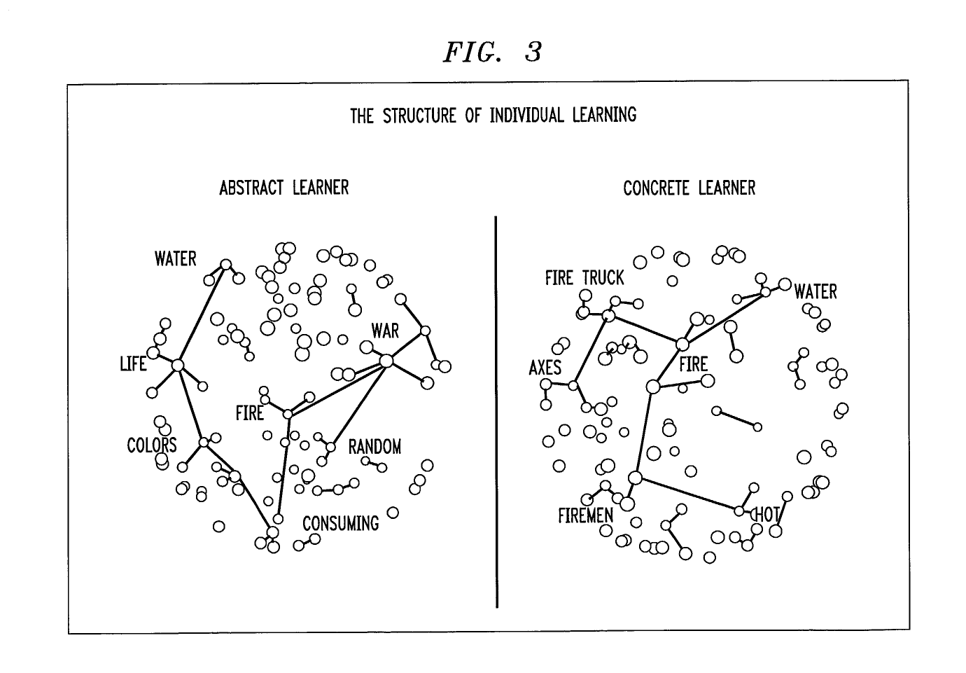

FIG. 4 contains a diagram illustrating the operation of a learning network for a plurality of different users;

FIG. 5 illustrates an exemplary graphical user interface (GUI) for interacting with a learning network formed in accordance with the present invention; and

FIG. 6 illustrates an exemplary learning network of the present invention, comprising as nodes knowledge objects, learning objects and competencies.

### DETAILED DESCRIPTION

Prior art systems utilized to implement a learning network have related competencies to learning content by either programming the relationship in software, or have used a search engine to identify the content via word strings. The shortcomings of programming the relationships center on the cost of creating the links, as well as an inability of the system to dynamically modify itself based on user needs. Using search engines to retrieve content is limited because the system identifies relevant documents based on key words, rather than on the actual concept presented in the document. In addition, neither system has the intelligence to learn from or adapt to the user's behavior. In other words, a learning architecture must be capable of incorporating new information, adapting existing relationships of content, and focusing on the interests of the user.

In recent years, the modeling of neural networks in software has reached a level of development that provides an opportunity to create individual learning networks. Specifically, algorithms are now available and capable of analyzing content and understanding meaning through the frequency and relationship of words. These correlations are formed independent of the content's language, grammar, sentence structure, and slang. The learning networks are created using “spiders” (i.e., loosely termed fetch utilities) that index the relationships between available content in most common and widely used file formats. Conceptually, this indexing, when queried, creates interconnects in the content that result in multilevel associations that mimic the node patterns, chunks, and schemas of the prior art parallel processing architecture. Further, the algorithms profile a user's interests based on actual queries and thus continually improve the meaning of the relationships in the user's learning network.

As mentioned above, these node patterns, chunks, and schemas are designed to provide individuals with mapped learning solutions to specific competency deficits. The structure of competencies often contains a mixture of knowledge, skills, abilities, motivation, beliefs, values, and interests. Competencies effectively translate the organizational mission, vision, and values into concrete behaviors and actions that individuals can understand and perform. Consequently, these behaviors and actions are utilized as “business drivers” for all human resource functions, including training.

Indeed, the assimilation of competencies into a learning network as the principle driver of training represents a significant evolution in the learning model. Instead of integrating competencies as word strings in a search engine, the competencies are treated as content and assimilated by the indexing utilities into a learning network. The process requires limited integration of existing systems into a learning architecture and also reduces the need for meta-tagging and definitive guidelines for chunking of information, since the index automatically acquires the related information.

As with any content introduced into a learning network, the relationships are automatically established between competencies and content, as well as among the content and competencies themselves. In the conventional parallel processing architecture, the node patterns that exist in the system may be accessed at multiple points. In keeping with the philosophy that competencies drive the business, a learning network formed in accordance with the present invention is accessed at the competency level associated with the particular individual doing the accessing. When competency nodes are opened, all related learning solution materials (both controlled and uncontrolled) are provided, subject to particular access rules that may be set forth by the organization's administrators.

The ability to customize each learning network in accordance with the present invention is intended to offer search results to a specific individual that are shaped by prior navigation, as well as gap analysis from a “competency road map”. The searching function uses preferences established by the particular functional organization (as the portal can provide different views for employees that access the hub from different functional organizations), as well as by personal settings that are made by the individual. The portal also promotes “communities of practice” by providing a forum for individuals to interact with instructors, application experts, and their peers on an ongoing basis (which functions to break the paradigm of event-centered learning).

The functionality described above may be accomplished using any neuralnetworking knowledge-management software application. In accordance with the present invention, four primary components are required to reside in the software: a concept engine, a data retrieval utility, a categorization tool, and a concept query capability. The concept engine serves as the core of the learning network and is capable of hosting a complete database of data acquired from multiple sources of information, in all commonly accepted file formats (including “zipped” material) throughout both the Internet and a company's intranet. Unlike other information databases, however, the concept engine applies algorithm(s) based in Bayesian statistical probability theory that statistically determine the meaning of content and stores an abstract of the content's concept with a hyperlink to the original source in its database.

The content residing in the concept engine is assembled using data retrieval utilities. These utilities are directed to retrieve content from both controlled and uncontrolled sources, including databases (e.g., Oracle Fetch and ODBC Fetch), web sites (Spiders), emails (MS Exchange Fetch), as well as a host of other content sources. The utilizes are capable of acquiring content on a scheduled basis and dynamically incorporating its meaning into the database.

Once established in the database of the concept engine, the content is queried using agents. The agent, using similar algorithms, is optimized through training on sample content to query the concept engine for related materials. The agent, once executed, is processed by the concept engine, yielding an index of materials correlated to the original query, regardless of the content's language, grammar, sentence structure, or use of slang. In other words, the agent's query is processed for meaning by the concept engine and compared to the abstracts of the content concepts in the indexed database. Once processed, the concept engine creates a relationship table of similar content based on the original query's meaning. The relationship table provides the user with a listing of hyperlinks produced by the original query.

The relationships created as a result of the initial query agent are intertwined into a multilevel set of associations that dynamically adapt to the content preferences of the user. Since the concept engine dynamically processes the original query, any further selections within the relationship table yield a new relationship table of hyperlinks. Furthermore, the algorithms provide a particular user's interests based on actual behavior and continually improve the meaning of the relationships found in the relationship table. In other words, as the first query is applied, the concept engine creates a list of related content. Once a hyperlink is selected, that material is presented with a new relationship table that is dynamically generated and specific to the new cont4ent. This process of dynamically created relationship tables is endless and demonstrates the ability of the software to personalize content delivery based on user preferences and past behavior. This process is capable of occurring on a much grander scale as multiple query agents searching on multiple subjects continually monitor the changing content being updated at scheduled intervals in the concept engine. The result of this approach is a set of relationship tables that represent a more “holistic” view of the user's ever-changing content environment.

The combination of the concept engine, data retrieval utilities, and agent query presents an example of an application capable of distributing customized content to users, based on individual preferences and past behavior. For the purposes of the present invention, however, another level of administrative direction is desired for a successful implementation of a dynamic, individualized learning network. In particular, as users choose hyperlinks associated with their personal concept agent, they risk a complete disassociation with the agent's original programming. For example, if a user is searching for training on “win-win negotiation”, the agent may provide a hyperlink to a document entitled “Win-Win Negotiation at Exxon”. Upon selection of that hyperlink, the new relationship table may include multiple hyperlinks to non-training materials, including content on the Exxon Valdez incident in Alaska. Without proper control, therefore, a user may be directed away from the content deemed important by the training organization.

One solution to this problem would be to restrict the content fed into the concept engine by the data retrieval utilizes. However, the cost of removing potential non-traditional learning opportunities (e.g., news stories, “lessons learned”, best practices and community groups) is considered to far outweigh the security that the restrictions provide. In contrast to limiting the types of content incorporated into the concept engine, an additional filter may be implemented, in accordance with the present invention, to limit the material accessible to a query agent in response to a specific request. More particularly, a category may be established that would be a subset of the concept engine's material focused on a particular concept. For instance, a “negotiation” category would limit the available hyperlinks when “win-win negotiations” were sought from the concept engine to only those other hyperlinks involving negotiation as a “concept” (thus not allowing the Valdez article to be selected). This administrative restriction thus provides the system with the ability to provide truly diverse content, while enabling control (when necessary) over content availability.

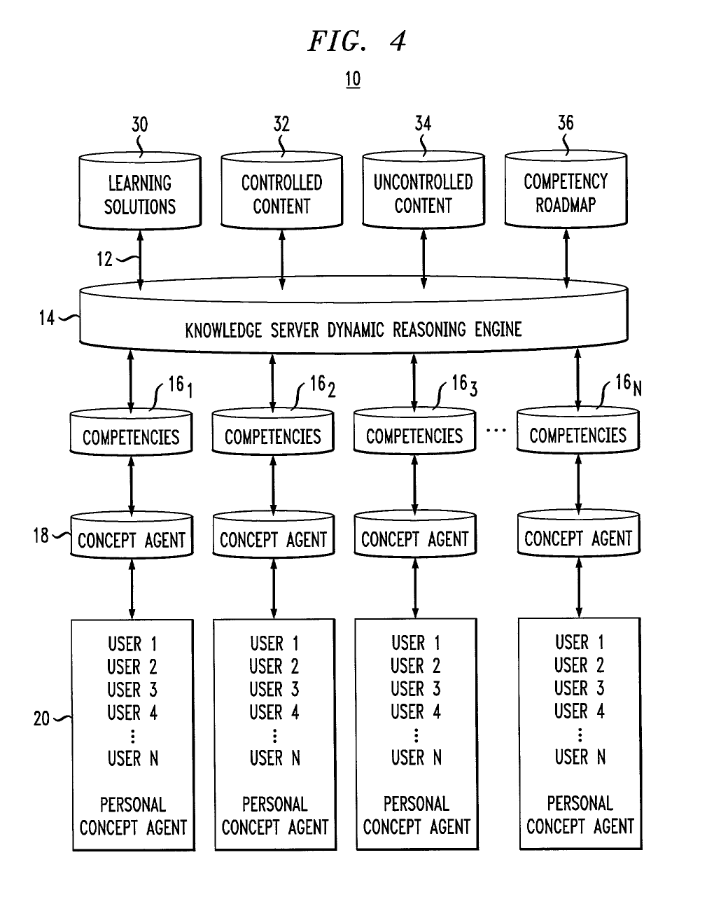

As presented, this application provides a robust system for the integration and delivery of diverse content in a personalized and continuously dynamic manner. An exemplary system 10 of the present invention, as illustrated in FIG. 4, is shown to integrate the concept of content acquired via a set of data retrieval utilities 12 into a concept engine database 14. Competencies 16-1, 16-2, 16-3, . . . , 16-N are then established to create subsets of content focused on specific competencies. A query agent 18 then queries a particular competency 16-i and, over time, query agent 18 for a specific user 20 becomes personalized for user 20 on a given competency. A neural-networking based software approach may be used with the dynamic learning network structure 10 of the present invention, since the inventive learning network can be thought of as a learning system based on a parallel processing architecture that enables people to encode and apply knowledge and skill to their jobs beyond the situation in which learned. Using specific software components, a parallel processing architecture can be established, where in particular the sources of content available to learners are established by the business through its training organization (and are considered to be infinitely customizable by groups of individuals).

Referring to FIG. 4, four difference sources of content are identified: learning solutions 30, controlled content 32, uncontrolled content 34, and a competency roadmap 36. Once the sources of content are identified, data retrieval utilities 12 are released to “scour” the associated content providers' network(s) (e.g., Internet, corporate intranet, etc.) for learning objects and knowledge objects to be incorporated into the learning network. In most cases, output files from content providers are not necessary, due to the ability of data retrieval utilities 12 to retrieve information from the content sources into concept engine 14. Once the content is retrieved, the concept engine statistically determines the meaning of the objects and stores the concept abstracts with a hyperlink in its database.

After the content in concept engine 14 is established, data retrieval utilities 12 are programmed to continually scour the content sources 30, 32, 34 and 36 for new material, where any new material found is then dynamically incorporated by meaning into the database of concept engine 14. With the database of concept abstracts so created, categories may be implemented to create a sub-group for each competency 16 in every organization's competency roadmap 36. A competency's category identifies appropriate content by processing example content provided by the administrators of the system. The categories, once trained, identify and capture suitable content from the concept engine. Each category, therefore, represents both the learning objects and knowledge objects available for a given competency.

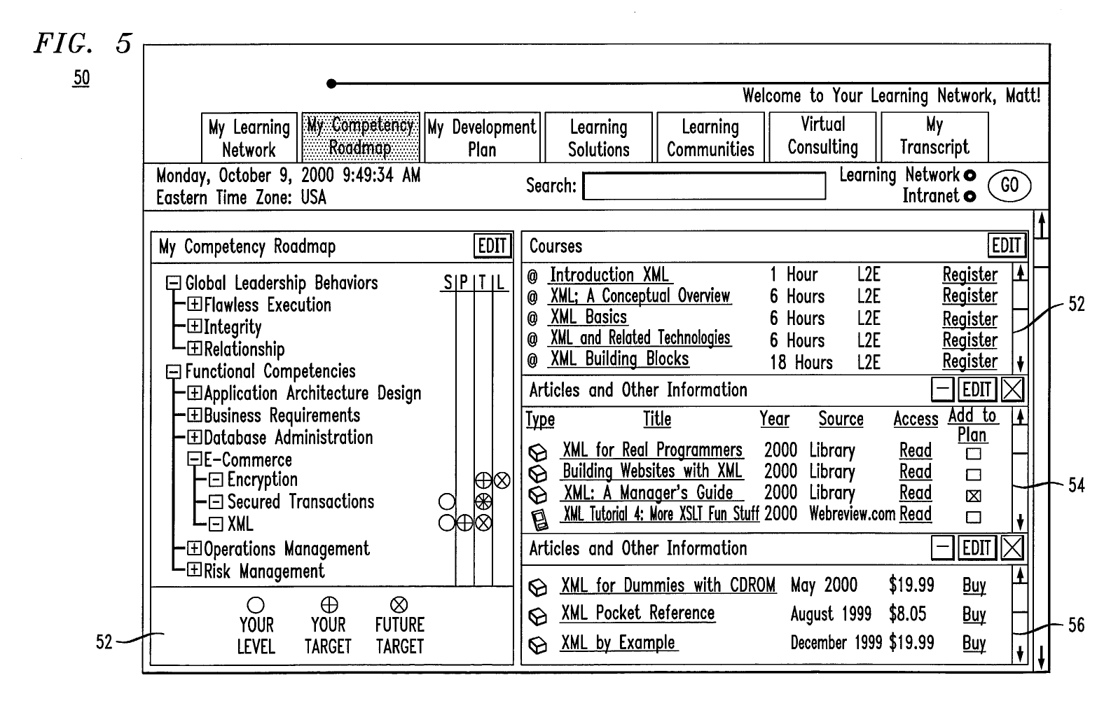

FIG. 5 illustrates an exemplary graphical user interface (GUI) 50 that may be used by an individual to gain entrance to an exemplary learning network of the present invention. As shown area 52 in the user interface 50 represents a series of possible competencies 16 in a competency roadmap 36. Each competency presented in area 52 on the interface 50 represents a trained category in concept engine 14. The categories contain specific content from the learning solutions 30, competency road map 36, controlled content sources 32 and uncontrolled content sources 34, pertaining to this competency.

After creating competency categories to provide administrative control over the types of content available to a user, the next step in the creation of the inventive learning network is the training of query agents on the types of content desired within each competency category. Although similar in purpose, the category is a subset of the concept engine based on a predefined concept. In contrast, the agents are structured database queries of the category to meet the specific learning needs of a user. The agents are trained by presenting to the agent an example of content that the learner is interested in locating within the concept engine's database.

Once the example is provided, the agent presents itself as a query statement to the concept engine for processing. The concept engine creates a concept abstract of the exemplary material and uses pattern matching and concept matching techniques to identify related materials in its database, which are then presented to the user in a relationship table. As mentioned above, multiple query agents may be programmed to search on multiple subjects, allowing for the continuous monitoring and presentation of relevant content to the user. Another method of applying the agents is to train multiple agents that retrieve different types of information from the same category. For instance, as shown in FIG. 5, windows 60, 62 and 64 display content that is dynamically retrieved from three separate agents 18-1, 18-2 and 18-3, being processed by concept engine 14 within the same category 16. More specifically, agent 18-1 associated with window 60 (“Courses”) is programmed to retrieve information from, for example, the Saba Learning Solutions database. Agent 18-2, associated with window 62 (“Articles and Other Information”) is programmed to retrieve relevant books from multiple magazine, journal and library resources, while window 64 associated with agent 18-3 is programmed to retrieve relevant information from a website.

The theoretical foundation of the inventive learning network, as described above, focuses on the ability of the learning system to automatically establish relationships across a catalog of data. The data, according to the theory, evolves from information schemas whose roots are based in chunks of content and nodes. The schemas are then processed in a parallel manner to create a network of knowledge.

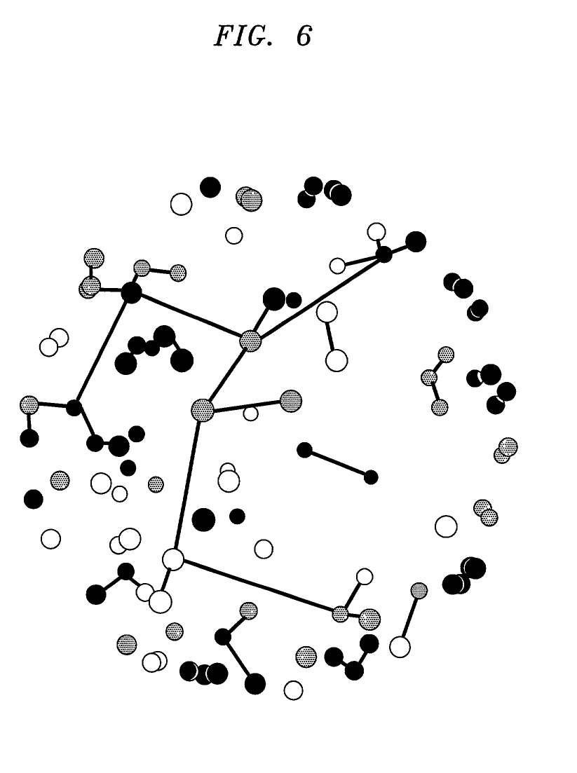

To this point, the concept of a network of interrelated content has been limited to the original output yielded by an agent's initial training. In other words, the concept engine processes the query statement of the agent and a return of interrelated material to the original query is provided. This, in and of itself, represents a learning network, since an infinite set of data resides in the concept engine (i.e., long-term memory) and is accessed at one point by a query agent (i.e., node), yielding a list of interrelated learning objects and knowledge objects representing the learning network. For example, FIG. 6 represents the relationship table (each node representing a hyperlink) in which the dark shaded nodes represent knowledge objects, the medium shaded nodes represent learning objects, and the light shaded nodes represent competencies. The agent's query statement represents the access of one node within a category in the concept engine that results in the stimulation of related nodes, equivalent to the activation of a schema in a learning network.

Although the content returned from the query is based on the “meaning” of the information, rather than on a simple word search, the material returned for a given agent is consistent for all individuals who use the query to access the concept engine. This representation of the query agent as a catalyst for the activation of a learning network does not fully represent the capability of the system. The true value of the system, as applied to a learning network, is that the relationship table changes as the user selects a hyperlink to access information related to the original search. The new relationship table is equivalent to a new activation pattern of nodes, or schema, in a learning network. This ability to customize a learning network to the user, based on preferences and past behavior, enables both novice and expert learners to maximize the benefits of the inventive system.

In particular, the learning network of the present invention provides novice learners with an expert system (or virtual coach) that aids in the encoding and organization of learning materials. This is important because novice learners tend to have difficulty understanding the relationship of new information to already-stored information. On the other hand, expert learners benefit from the organization of materials in the network, related to a more efficient utilization of time. The virtual coach is able to recommend learning solutions that others within the organization with a similar competency road map have been found effective. This provides experts with the ability to create encoding synergy by incorporating multiple types of information into various learning networks, resulting in a richer personal learning experience as related to the ability to manage more content in less time. The scalability of the inventive learning network to manage current data while constantly incorporating new data by meaning provides a learning solution capable of increasing the intellectual capital of a business, as a result of the flexibility of the system to meet the individual needs of each user.

In summary, the present invention is directed to a system based on a parallel processing architecture that enables an individual to encode and apply knowledge and skill to his job beyond the situation in which it is learned. The dynamic learning network of the present invention provides an expert system (i.e., virtual coach) to novice learners that aids in encoding and organizing learning materials. Similarly, expert learners benefit from the organization of materials in the network, resulting in a more efficient use of time. The virtual coach is also able to recommend learning solutions that others within the organization, with a similar competency roadmap, have found effective. The system of the present invention thus provides a competency-based learning system that leverages its identified knowledge, skills, abilities, motivation, beliefs, values and interests of the organization to drive the development of training programs in a continuous improvement cycle. The evaluation of the learning system may also be competency driven, and is therefore capable of identifying learning trends, improving the competency roadmap function, and maintaining overall learning system quality, resulting in the production of more robust learning solutions. The architecture is based on competencies shaping training, assessments improving the training, and training reshaping the competencies. Ultimately, the ability of the architecture to adapt leads to a more competent workforce capable of exceeding the needs of the organization.

What is claimed is:

1. A learning network arrangement comprising
a plurality of interconnected nodes representing subject matter elements for said learning network, the plurality of interconnected nodes including a first set of nodes associated with knowledge objects, a second set of nodes associated with learning objects, and a third set of nodes associated with competencies, wherein the first, second and third sets of nodes are linked in a pattern unique for each user of said learning network, where a plurality of nodes are linked to form a chunk, a plurality of chunks are linked to form a schema, and a plurality of schemas are linked to form the learning network; and
at least one query agent for accessing a competency node associated with a query submitted by a user, the competency node being linked to associated competency, knowledge and learning nodes.

2. A learning network as defined in claim 1 wherein the network is dynamic such that new links are created each time a user submits a query to said at least one query agent.

3. A learning network as defined in claim 1 wherein the network further comprises subject matter filters to minimize spurious return of information on a query.

4. A learning network as defined in claim 1 wherein the network comprises
a concept engine including a database for storing concept information and the linkage between the plurality of nodes in the network; and
a plurality of data retrieval utilities, associated with the concept engine, for accessing external information sources and creating knowledge and learning nodes in the learning network.

5. A learning network as defined in claim 4 wherein the plurality of data retrieval utilities are configured to continuously access the external information sources and create new knowledge and learning nodes.

6. A learning network as defined in claim 4 wherein the external sources comprise both controlled and uncontrolled sources of information.

7. A learning network as defined in claim 6 wherein the external sources further comprise learning solutions and a competency roadmap.
